(19) United States
(12) Patent Application Publication
(10) Pub. No.: US 2006/0103344 A1
(43) Pub. Date: May 18, 2006

(54) Providing power from a power storage unit in a first computing device to a second computing device

(76) Inventors: Vishwa Hassan, Bangalore (IN); Sandeep Bhatia, Hyderabad (IN)

Correspondence Address: BUCKLEY, MASCHOFF, TALWALKAR LLC, 5 ELM STREET, NEW CANAAN, CT, 06840, US

(21) Appl. No.: 10/991,143

(22) Filed: Nov. 17, 2004

(51) Int. Cl. H02J 7/00

(52) U.S. Cl. 320/103

(57) ABSTRACT

According to some embodiments, power is stored in a first power storage unit located at a first computing device. The power is then provided from the first power storage unit to a second computing device, wherein the second computing device is external to the first computing device, and wherein the first and second computing devices are the same type of device.

### BACKGROUND

Some computing devices are powered by a power storage unit. For example, a processor and display of a laptop computer might be powered by a battery. In this way, the laptop computer can be used when it is not connected to a stationary power source, such as an Alternating Current (AC) outlet.

As the computing device is used, the amount of power available in the power storage unit will decrease. Eventually, there will not be enough power remaining in the power storage unit will to operate the device. Typically a user would bring the device near a stationary power source (e.g., an AC outlet) to re-charge battery. In some cases, however, this is not practical. For example, the user might be in an airplane or restaurant without an AC outlet when the device stops operating.

### BRIEF DESCRIPTION OF THE DRAWINGS

FIG. 1 is a block diagram of a computing system.

FIG. 2 is a block diagram including a first computing device and a second computing device according to some embodiments.

FIG. 3 is a flow diagram illustrating a method according to some embodiments.

FIG. 4 illustrates a first laptop computer providing power to a second laptop computer according to some embodiments.

FIG. 5 is a block diagram of a mobile computer according to some embodiments.

FIG. 6 is a block diagram of a system according to some embodiments.

FIG. 7 is a flow diagram illustrating a method according to some embodiments.

FIG. 8 is a block diagram of a computing device system according to some embodiments.

### DETAILED DESCRIPTION

Some embodiments described herein are associated with “computing devices.” As used herein, the phrase “computing device” may refer to any of a number of different types of devices. For example, a computing device might be a mobile computer, such as a laptop computer, a notebook computer, a tablet Personal Computer (PC), a hand-held computer, a Personal Digital Assistant (PDA) computer, a game device, or a wireless communication device (e.g., a cellular telephone). As another example, a computing device may be adapted to provide audio output in accordance with audio layer 3 of the Motion Picture Experts Group (MPEG) 1 protocol as defined by International Organization for Standardization (ISO)/International Engineering Consortium (IEC) document number 11172-1 entitled “Information Technology—Coding of Moving Pictures and Associated Audio for Digital Storage Media” (1993) (MP3).

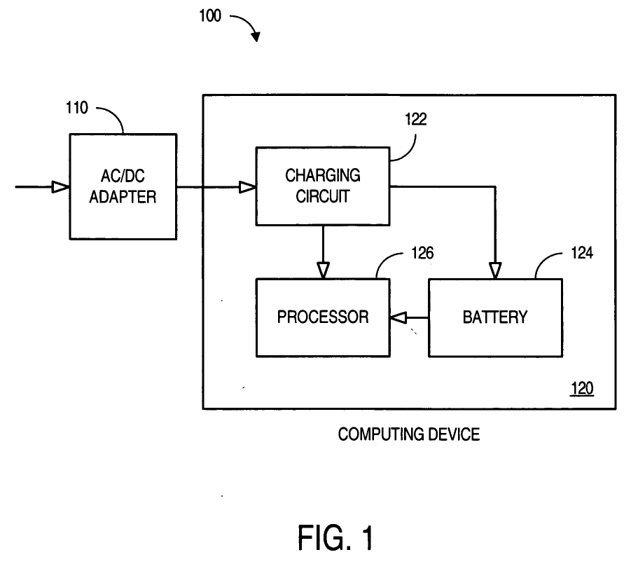

FIG. 1 is a block diagram of a computing system 100. In particular, the system 100 includes an AC-to-Direct Current (AC/DC) adapter 110 that may receive AC power from a wall outlet and provide DC power to a computing device 100. For example, a charging circuit 122 in the computing device 120 may use the DC power to charge a battery 124. In some cases, the charging circuit 122 may also provide power to a processor 126 when the AC/DC adapter 110 is present.

When the AC/DC adapter 110 is not present, the battery 124 may provide power to operate the processor 126 and/or other units in the device 120 (e.g., a display unit, an information storage unit, or a wireless communication unit). The amount of power available in the battery 124 will decrease until, eventually, there is not enough power left to operate the computing device 120. Typically, a user would bring the device 120 near a stationary power source (e.g., an AC outlet) to re-charge battery 124. In some cases, however, this approach is not practical (e.g., when no AC outlet is available to the user).

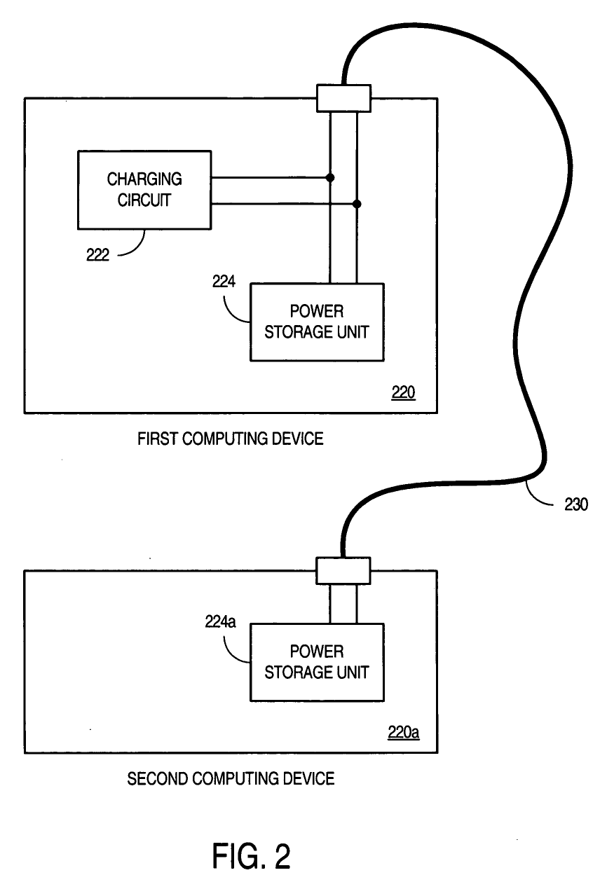

FIG. 2 is a block diagram including a first computing 220 device and a second computing device 220a according to some embodiments. The first computing device 220 may include a first power storage unit 224 and the second computing device 220a may include a second power storage unit 224a. Either of the power storage units 224, 224a might be, for example, a battery, such as a Li-Ion device, a NiCad device, a NiMH device, a sealed lead-acid device, and/or a lithium metal device. According to some embodiments, either of the power storage units 224, 224a may be a fuel cell (e.g., such as a pure hydrogen, methanol, reformed methanol, ethanol, and/or any other currently- or hereafter-known fuel cell).

The first power storage unit 224 may be located at the first computing device 220. For example, the first power storage unit 224 might be mounted in a device-bay slot, a dedicated battery pack slot, and/or a pack coupled to the first computing device 220. Note that although a single power storage 224 unit is illustrated in FIG. 2, any number of power storage units may be included in the first computing device 220. The first power storage unit 220 may also be coupled to a charging circuit 222 (e.g., a fast-charging circuit that senses the level of power in the power storage unit 224 and/or routes AC or DC power from an external source to the power storage unit 224).

Note that the first and second computing devices 220, 220a can be the same type of device. For example, the first and second computing devices 220, 220a could both be laptop computers or PDAs. Although the two devices 220, 220a can be the same type of device, note that they may be different models and/or be associated with different manufacturers. For example, the first device 220 might be a DELL® laptop computer while the second device 220a is a COMPAQ® laptop computer.

Assume now that the first power storage unit 224 is storing sufficient power to operate the first computing device 220 while that the second power storage unit 224a is not storing sufficient power to operate the second computing device 220a. According to some embodiments, a cable 230 may attached between the first computing device 220 and the second computing device 22a. Moreover, the cable 230 may be used to provide power from the first power storage unit 224 directly to the second power storage unit 224a. That is, the power storage unit 224 of the first computing device 220 can be used to charge the power storage unit 224a of the second computing device 220a. In this way, the second computing device 220a might be operated without requiring the presence of a typical AC power source or AC/DC adapter.

The charging circuit 222 might include a Voltage Regulator (VR) to charge the power storage unit 224 and/or to convert power that is received from the power storage unit 224 at a first voltage (and/or current) level to a second voltage (and/or current) level. The charging circuit 222 might also include one or more current-sensing resistors to detect and control the voltage and current levels of charging power supplied to the power storage unit 224. Moreover, the charging circuit 222 might include one or more decoupling capacitors and DC/DC converters to provide different voltage levels suitable for various system loads, such as 5 Volts (V), 3.3V, or 1V.

According to some embodiments, elements of the first computing device 220, including the charging circuit 222, are arranged pursuant to the September 2003 Narrow VDC Extended Battery Life (BELL) Technique presentation by Intel Corporation®. Other arrangements may be employed in some embodiments. Moreover, a system management controller may provide low-level control over some aspects of first computing device 220, such as input device control and control over power consumption modes. The system management controller may communicate with and/or control the charging circuit 222, the power storage unit 224, and various system loads via a system management bus (SMBus) in accordance with System Management Bus (SMBus) Specification, ver. 2.0, Aug. 3, 2000, © 2000 SBS Implementers Forum. Implementation details of such functionality are known to those in the art and are included in the NVDC EBL specification. Moreover, elements of the first computing device 220 might operate pursuant to the Advanced Configuration and Power Interface (ACPI) Specification Revision 2.0b (October, 2002).

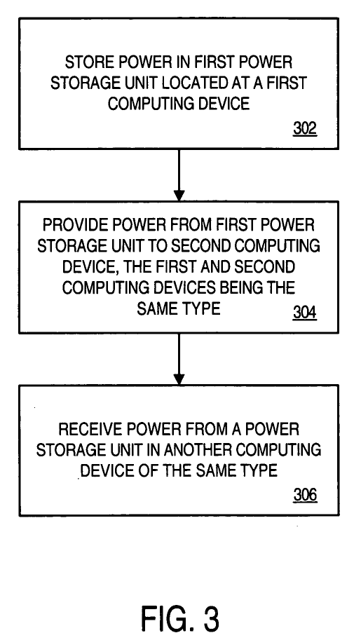

FIG. 3 is a flow chart of a method according to some embodiments. The method of FIG. 3 may be associated with, for example, either of the computing devices 220, 220a described with respect to FIG. 2. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine results in performance according to any of the embodiments described herein.

At 302, power is stored in a first power storage unit located at a first computing device. For example, an AC/DC adapter may be used to charge a battery in a first PDA. At 304, power is provided from the first power storage unit to a second computing device. Note that the second computing device may be external to the first computing device (e.g., a separate device), and the first and second devices may be the same type of device.

According to some embodiments, power from the first power storage unit is provided directly to a processor of the second computing device. For example, power from a first PDA'S battery might be used to operate a second PDA (e.g., without charging the second PDA's battery). According to other embodiments, power from the first power storage unit is provided directly to the second computing device's power storage unit. For example, power from a first PDA'S battery might be used to charge a second PDA's battery. According to still other embodiments, power from the first power storage unit might be used to both operate the second computing device and charge the second computing device's power storage unit.

According to some embodiments, the first computing device can also receive power from another device's power storage unit at 306 (e.g., another device of the same type). That is, the first computing device can be a power source (e.g., when it has power and another device does not) or a power load (e.g., when it does not have power and another device does).

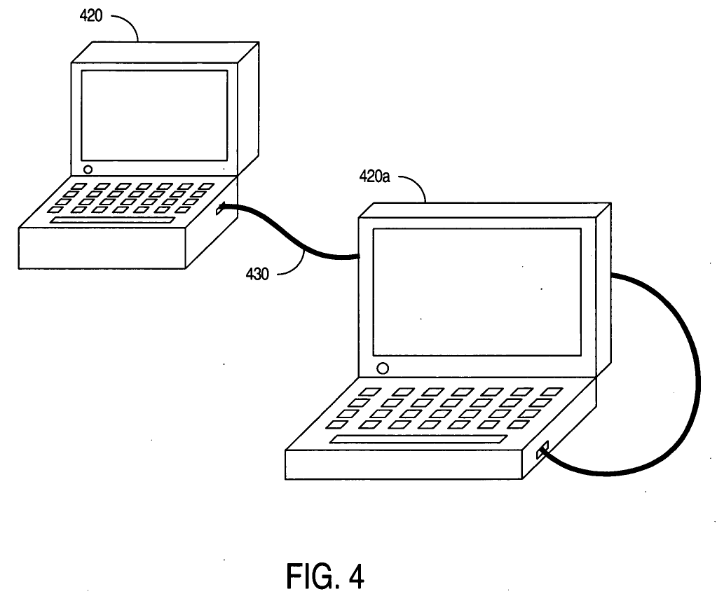

FIG. 4 illustrates a first laptop computer 420 providing power to a second laptop computer 420a according to some embodiments. In particular, a cable 430 attached between the first laptop computer 420 and the second laptop computer 420a may be used to transfer power from a battery at the first laptop computer 420 to a processor and/or battery at the second laptop computer 420a.

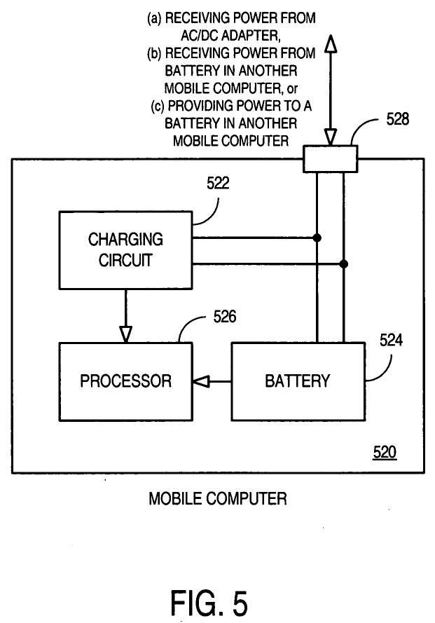

FIG. 5 is a block diagram of a mobile computer 520 according to some embodiments. In particular, a charging circuit 522 may receive power from an external AC/DC adapter via a power port 528. The charging circuit 522 may use this power, for example, to operate a processor 526 and/or to charge a battery 524 (e.g., so that the mobile computer 520 can operate when the external AC/DC adapter is not present). According to some embodiments, the AC/DC adapter is located within the mobile computer 520.

According to this embodiment, the power port 528 may also be used to receive power from a battery at another mobile computer. For example, a cable connected between the power port 528 and the other computer may transfer power to the processor 526 (e.g. via the charging circuit 522) and/or to the battery 524. The power port 528 may be, for example, associated with a pair of battery tap points that are accessible to another device of the same type (e.g., another mobile computer). Note that in any of the embodiments described herein, a power port may also serve another function (e.g., a communication port might include battery tap points).

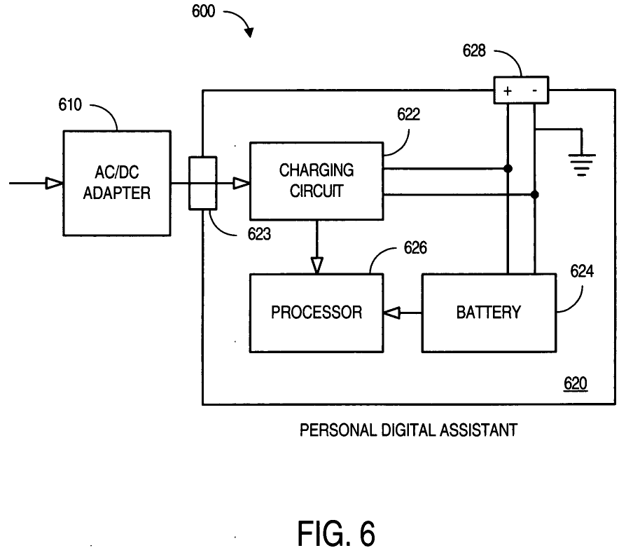

FIG. 6 is a block diagram of a system 600 including an AC/DC adapter 610 and a PDA 620. According to this embodiment, a charging circuit 622 in the PDA 620 receives power from the AC/DC adapter 610 via a first power port 623. The charging circuit 622 may use this power, for example, to operate a processor 626 and/or charge a battery 624. According to this embodiment, a second power port 628 includes positive and ground battery tap points that can be accessed by another PDA. The second power port 628 might be used, for example, to provide power to the other PDA and/or to receive power from the other PDA (e.g., and power received from the other PDA might be used to operate the processor 626 and/or charge the battery 624). According to some embodiments, the power from the AC/DC adapter 610 can be routed directly to the other PDA (e.g., via the charging circuit 622 and without operating the processor 626 or charging the battery 624).

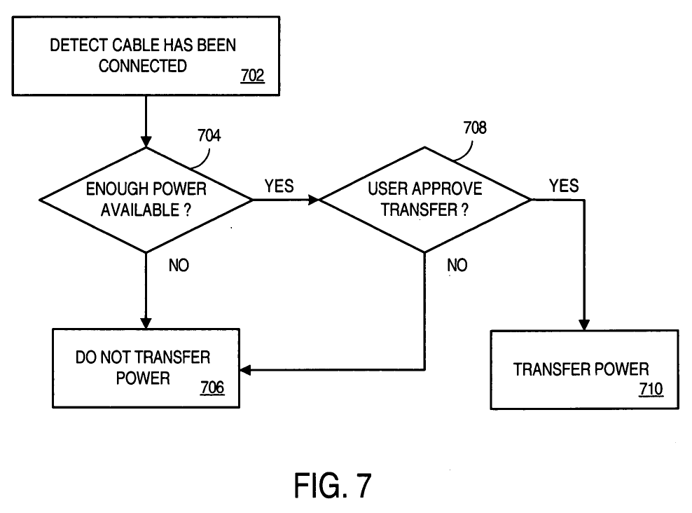

FIG. 7 is a flow diagram illustrating a method according to some embodiments. In this case, a software program (e.g., associated with an operating system, driver, or power management application) executing at a first computing device detects that a cable has been connected to a power port at 702. It is then determined at 704 whether or not the first computing device has enough power available to support another computing device. The first computing device might determine, for example, if a threshold level of power is currently available from a battery or an AC/DC adapter. If sufficient power is not currently available, no power is transferred to the other computing device at 706.

If sufficient power is currently available, it is determined at 708 whether or not a user approves of a transfer of power to the other computing device. For example, the following message might automatically appear on a display of the first computing device when the cable is detected: “Another laptop computer is attempting to access power from this laptop computer. Click OK to provide power or CANCEL to not provide power.” If the user does not indicate that he or she approves the transfer, no power is provided to the other computing device at 706. If the user does approve the transfer, power is transferred from the first computing device to the second computing device at 710.

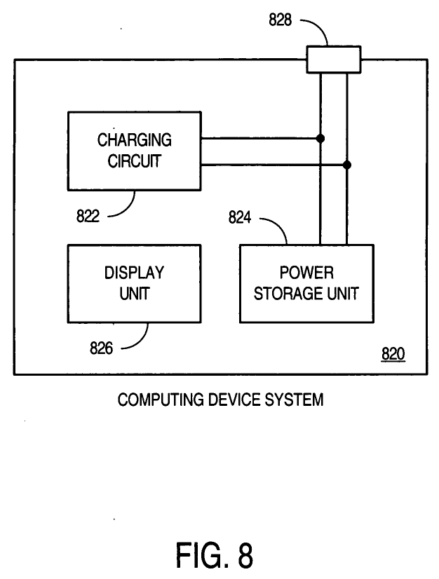

FIG. 8 is a block diagram of a computing device system 800 according to some embodiments. The system 820 includes a charging circuit 822 that may be used to provide power to a power storage unit 824 (e.g., a battery). Moreover, a pair of battery tap points are accessible to another computing device of the same type via a power connector 828. The power connector 828 may be used, for example, to provide power to or receive power from the other computing device. According to this embodiment, the computing device system 520 further includes a display unit 826, such a Liquid Crystal Display (LCD) unit. According to other embodiments, a computing device system 520 might not include a display unit 826 (e.g., a portable MP3 player might not include a display unit).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a cable has been illustrated as facilitating a transfer of power from a first device to a second device, any embodiments may be provided without a cable. For example, a power port of a first computing device might connect directly to a power port of a second computing device. As another example, inductive coupling may be used to transfer power between devices.

Moreover, although particular arrangements have been illustrated, embodiments may include other arrangements and/or components. For example, protective and/or isolation components may be used to prevent damage to a battery or other elements within a computing device.

The several embodiments described herein are solely for the purpose of illustration. Persons skilled in the art will recognize from this description other embodiments may be practiced with modifications and alterations limited only by the claims.

What is claimed is:

1. A method, comprising:
storing power in a first power storage unit located at a first computing device; and
providing power from the first power storage unit to a second computing device, wherein the second computing device is external to the first computing device, and wherein the first and second computing devices are the same type of device.

2. The method of claim 1, wherein said providing power comprises providing power directly to a processor of the second computing device.

3. The method of claim 1, wherein said providing power comprises providing power directly to a second power storage unit associated with the second computing device.

4. The method of claim 3, wherein at least one of the first and second power storage units comprise at least one of: (i) a battery, or (ii) a fuel cell.

5. The method of claim 1, wherein the first and second computing devices are both: (i) mobile computers, (ii) notebook computers, (iii) tablet personal computers, (iv) laptop computers, (v) hand-held computers, (vi) personal digital assistants, (vii) game devices, (viii) wireless communication devices, or (ix) audio devices.

6. The method of claim 1, wherein said storing includes:
receiving power from an AC-to-DC adapter external to the first computing device.

7. The method of claim 1, wherein said providing is performed via a cable between a first pair of battery tap points associated with the first computing device and a second pair of battery tap points associated with the second computing device.

8. The method of claim 1, further comprising:
receiving at the first computing device power from the second computing device.

9. An apparatus, comprising:
a battery located at a first mobile computer; and
a power output to provide power to a second mobile computer, wherein the first and second mobile computers are the same type of device.

10. The apparatus of claim 9, wherein the power output is to provide power directly to a processor of the second mobile computer.

11. The apparatus of claim 9, wherein the power output is to provide power directly to a second battery associated with the second mobile computer.

12. The apparatus of claim 11, wherein battery is at least one of: (i) Li-Ion device, (ii) an NiCad device, (iii) an NiMH device, (iv) a sealed lead-acid device, or (v) a lithium metal device.

13. The apparatus of claim 9, wherein the first and second mobile computers are associated with at least one of: (i) different models, or (ii) different manufacturers.

14. The apparatus of claim 9, further comprising:
a power input to receive power from an AC-to-DC adapter external to the first mobile computer.

15. The apparatus of claim 14, further comprising:
a charging circuit to route the power from the AC-to-DC adapter to the first battery.

16. The apparatus of claim 14, wherein the power output also acts as the power input.

17. The apparatus of claim 14, wherein the power output is separate from the power input.

18. The method of claim 9, wherein the power output is associated with a first pair of battery tap points associated with the first mobile computer and is further adapted to be connected to a second pair of battery tap points associated with the second mobile computer via a cable.

19. A system, comprising:
a display unit;
a power storage unit located at a first electronic mobile device; and
a power connector to provide power to a second electronic mobile device, wherein the first and second electronic mobile devices are the same type of device.

20. The system of claim 19, further comprising:
a cable to be attached between the power connector and another power connector associated with the second electronic mobile device.

21. The system of claim 19, wherein a processor of the first electronic mobile device is to determine whether or not power is to be provided to the second electronic mobile device.

22. The system of claim 19, wherein a user of the first electronic mobile device is to determine whether or not power is to be provided to the second electronic mobile device.
